(19) United States
(12) Patent Application Publication
(10) Pub. No.: US 2015/0116220 A1
(43) Pub. Date: Apr. 30, 2015

(54) CURSOR CONTROL DEVICE AND INPUT METHOD THEREOF WITH MULTIPLE OPERATIONS AT AN INPUT

(71) Applicant: DEXIN CORPORATION, New Taipei City (TW)

(72) Inventor: YUAN-JUNG CHANG, NEW TAIPEI CITY (TW)

(73) Assignee: DEXIN CORPORATION, New Taipei City (TW)

(21) Appl. No.: 14/068,147

(22) Filed: Oct. 31, 2013

(51) Int. Cl. G06F 3/0354

(52) U.S. Cl. CPC G06F 3/03543
USPC 345/163

(57) ABSTRACT

The present invention provides a cursor control device and an input method thereof with multiple operations at an input, which can control a cursor shown on a display unit of an electronic device. The cursor control device comprises a connecting unit, an operating interface, a memory unit, and a controlling unit. The connecting unit is electrically connected to the electronic device. The controlling unit starts and executes rapid instructions through the operation of the operating interface. Then, the controlling unit transmits operating instructions to the electronic device sequentially. Operating instructions are executed at one or more target position data correspondingly to show on the display unit so as to improve the convenience for user using the cursor control device.

### BACKGROUND

1. Technical Field

The present invention relates to a control device and an input method thereof, in particular, to a cursor control device and an input method thereof.

2. Description of Related Art

When a user operates a computer, an input device is required for transmitting an instruction to the computer. There is a variety of input device, and a mouse is a more intuitive and convenient one.

The conventional mouse has not only the general control button (e.g., left mouse button, right mouse button, and mouse scroll wheel) but also many hot keys having special functions. Thus, when the user operates the mouse, the user only presses one hot key, and the corresponding instructions can be executed. For example, when the user plays strategy games, the user can press the hot key of the mouse to execute the attack or the defense.

### SUMMARY

One objective of the present invention is to provide a cursor control device and an input method thereof with multiple operations at an input, so as to execute actions on one or more target position data through a rapid instruction of the cursor control device and then show the result on the screen. Thus, the cursor control device and the input method thereof can improve the convenience in usage.

According to one exemplary embodiment of the present invention, a cursor control device with multiple operations at an input is provided. The cursor control device is used to control a cursor, which is shown on a display unit of an electronic device. The cursor control device includes a connecting unit, an operating interface, a memory unit, and a controlling unit. The connecting unit electrically connects to the electronic device. The memory unit stores at least one rapid instruction. Each of the rapid instruction has a plurality of target position data. Each of the target position data corresponds to at least one operating instruction. The controlling unit electrically connects to the connecting unit, the operating interface and the memory unit. The controlling unit starts and executes the rapid instruction according to the operation of the operating interface. When the controlling unit executes the rapid instruction, the controlling unit transmits the operating instructions to the electronic device according to a processing schedule through the connecting unit, so that the electronic device executes the operating instruction on each of the target position data correspondingly and displays each of the target position data on the display unit.

According to one exemplary embodiment of the present invention, a cursor control device with multiple operations at an input is provided. The cursor control device is used to control a cursor, which is shown on a plurality of display units of an electronic device. The cursor control device includes a connecting unit, an operating interface, a memory unit, and a controlling unit. The connecting unit electrically connects to the electronic device. The memory unit stores at least one rapid instruction. Each of the rapid instruction has a plurality of target position data. Each of the target position data corresponds to at least one operating instruction. The controlling unit electrically connects to the connecting unit, the operating interface and the memory unit. The controlling unit activates and executes the rapid instruction according to the operation of the operating interface. When the controlling unit executes the rapid instruction, the controlling unit transmits the operating instructions to the electronic device according to a processing schedule through the connecting unit, so that the electronic device executes the operating instruction on each of the target position data correspondingly and displays each of the target position data on the display units.

According to one exemplary embodiment of the present invention, an input method of a cursor control device with multiple operations at an input is provided. The input method of the cursor control device is used to control a cursor, which is shown on a display unit of an electronic device. The input method of the cursor control device includes the following step: A) determining whether to start a rapid instruction stored in the cursor control device. The rapid instruction has a plurality of target position data, and each of the target position data corresponds to at least one operating instruction. B) when the rapid instruction is started, the cursor control device executes the rapid instruction. When the cursor control device executes the rapid instruction, the cursor control device transmits the operating instructions to the electronic device according to a processing schedule, so that the electronic device executes the operating instruction on each of the target position data correspondingly and displays each of the target position data on the display unit.

In order to further understand the techniques, means and effects of the present invention, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present invention.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain the principles of the present invention.

FIG. 1 shows a diagram of a cursor control device connecting to a computer according to an exemplary embodiment of the present invention.

FIG. 2A shows a block diagram of the cursor control device according to the exemplary embodiment of the present invention.

FIG. 2B shows a flowchart of an input method of the cursor control device according to the exemplary embodiment of the present invention.

FIG. 3A shows a diagram of using the cursor control device and executing an operating instruction on a specific position of a display unit according to the exemplary embodiment of the present invention.

FIG. 3B shows a diagram of a setup field according to the exemplary embodiment of the present invention.

FIG. 3C shows a diagram of another setup field according to the exemplary embodiment of the present invention.

FIG. 4A shows a diagram of a battlefield map according to another exemplary embodiment of the present invention.

FIG. 4B shows a diagram of using the cursor control device and executing an operating instruction on a specific position of a display unit according to another exemplary embodiment of the present invention.

FIG. 4C shows a diagram of a setup field according to another exemplary embodiment of the present invention.

FIG. 4D shows a diagram of another setup field according to another exemplary embodiment of the present invention.

### DESCRIPTION OF THE EXEMPLARY EMBODIMENTS

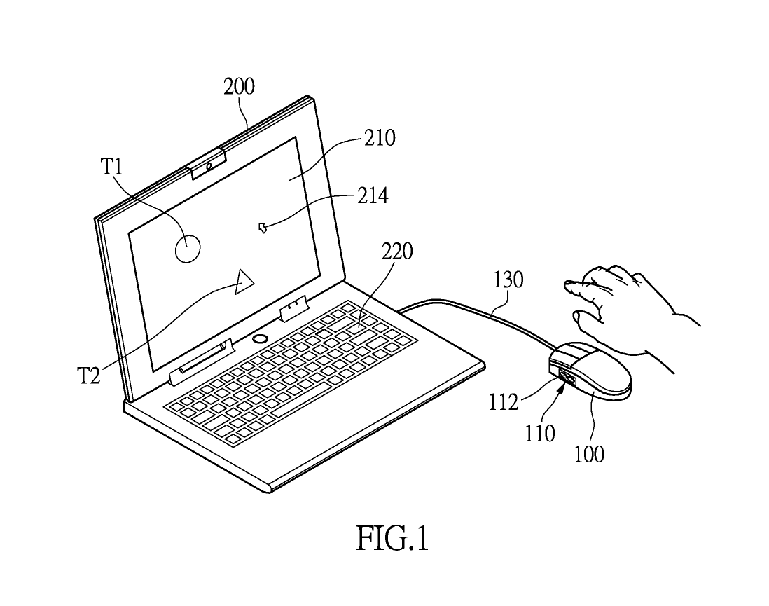

Firstly, please refer to FIG. 1. FIG. 1 shows a diagram of a cursor control device connecting to a computer according to an exemplary embodiment of the present invention. As shown in FIG. 1, the cursor control device 100 electrically connects to the electronic device 200 through the connecting unit 130, so that the cursor control device 100 can control the cursor 214 shown on the display unit 210 of the electronic device 200 through pressing the function button of the operating interface 110. Then cursor control device 100 executes the operating instructions on target position data T1, T2 shown on the display unit 210. In the exemplary embodiment, the target position data T1, T2 correspond to the specific position of the display unit 210 respectively or correspond to the specific position of the map, e.g., the battlefield map of the computer games. It means that a user employs the cursor control device 100 to execute the corresponding operating instruction on the target position data T1, T2, and then display the result on the display unit 210. The operating instruction includes, for example, executing one of the command from keyboard keys of the keyboard 220 and/or executing one of the command from mouse buttons of the cursor control device 100. In addition, in the exemplary embodiment, the cursor control device 100 is a mouse. The electronic device 200 is a portable computer. The cursor control device 100 can be a remote control, joystick or any other cursor control devices, which can execute the operating instruction on the target position data T1, T2. The present invention is not limited thereto.

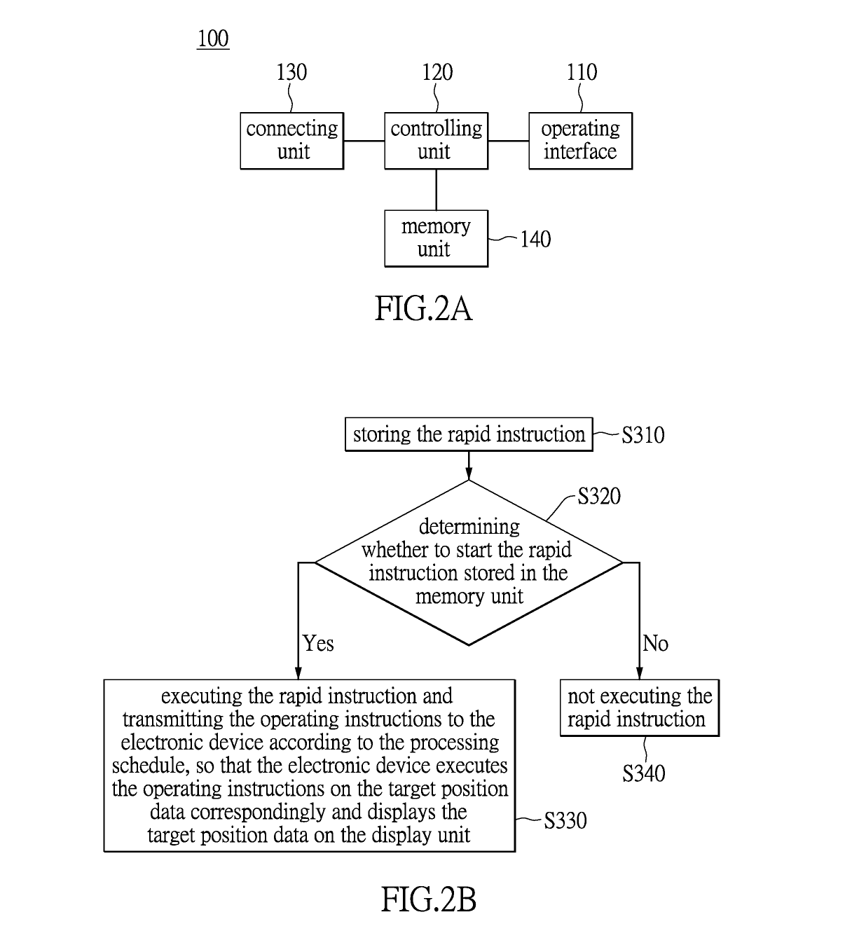

Please refer to FIG. 2A. As shown in FIG. 2A, the cursor control device 100 includes the operating interface 110, the controlling unit 120, the connecting unit 130 and the memory unit 140. The connecting unit 130 electrically connects to the electronic device 200 through the universal serial bus (USB). In the exemplary embodiment, the connecting unit 130 can connect to the electronic device 200 through other input/output interfaces, e.g., PS/2. In addition, the connecting unit 130 can also connect to the electronic device 200 through the wireless input/output interfaces, such as Bluetooth, infrared ray (IR), radio frequency (RF) technology or the like. The present invention is not limited thereto.

The memory unit 140 stores at least one rapid instruction. Each of the rapid instruction has many target position data. Each of the target position data corresponds to at least one operating instruction. As shown in FIG. 1, each of the function buttons (e.g., the function button 112) of the operating interface 110 corresponds to a rapid instruction respectively. Each of the rapid instruction stores many target position data T1, T2. The target position data T1, T2 have the operating instruction respectively and are shown on the display unit 210. For example, the target position data T1 corresponds to the operating instruction “SPACE”. The target position data T2 corresponds to the operating instructions “right mouse button” and “H”. In the exemplary embodiment, the operating instruction can be obtained from the input instruction of the operating interface 110 (e.g., the command from the left mouse button or the right mouse button) and/or can be obtained from the keyboard command of the keyboard 220 of the electronic device 200 (e.g., alphabetic keys, numeric keys or function keys). In addition, the target position data T1, T2 of the exemplary embodiment correspond to the specific position of the display unit 210 respectively and are shown on the display unit 210. For example, the display unit 210 has 1280×768 pixels as shown in FIG. 1. The target position data T1 is located on the coordinates (400, 300) of the display unit 210. The target position data T2 is located on the coordinates (700, 500) of the display unit 210. The target position data T1, T2 may be located by the specific positions of other maps, e.g., by the absolute coordinate of the battlefield map of the computer game. The present invention is not limited thereto. It is worth noting that the target position data can be a target (e.g., the target position data T1, T2 have circle and triangle respectively) or can be a position (e.g., the target position data T1, T2 are located at the specific positions of the map respectively), and the present invention is not limited thereto. In order to describe the exemplary embodiment conveniently, the following regards the target position data as the target.

The controlling unit 120 electrically connects to the connecting unit 130, the operating interface 110 and the memory unit 140. The controlling unit 120 starts and executes the rapid instruction according to the operation of the operating interface 110. When the controlling unit 120 executes the rapid instruction, the controlling unit 120 transmits the operating instructions to the electronic device 200 according to a processing schedule through the connecting unit 130, so that the electronic device 200 executes the operating instruction on each of the target position data correspondingly and displays each of the target position data on the display unit 210. For example, the cursor 214 executes the operating instruction “SPACE” on the target position data T1, and the result is shown on the display unit 210, or the cursor 214 executes the operating instruction “right mouse button” and “H” on the target position data T2, and the results are shown on the display unit 210.

As shown in FIG. 2B, the input method of the cursor control device 100 entering the rapid instruction to the electronic device 200 is described as follows. Firstly, the memory unit 140 stores the rapid instruction. The rapid instruction corresponds to the function button 112 of the operating interface 110 (step S310). Then the controlling unit 120 determines whether to start the rapid instruction stored in the memory unit 140 (step S320). When the controlling unit 120 receives the rapid instruction corresponding to the function button 112 (e.g., the function button 112 is pressed), the controlling unit 120 obtains the rapid instruction corresponding to the function button 112 from the memory unit 140 and then executes the rapid instruction. Subsequently, the controlling unit 120 transmits the operating instructions to the electronic device 200 sequentially according to the processing schedule through the connecting unit 130, so as to execute the corresponding operating instruction at each of the target position data (e.g., the target position data T1, T2) and show the result on the display unit 210 (step S330). When the controlling unit 120 does not receive the rapid instruction corresponding to the function button 112 (e.g., the function button 112 is not pressed), the controlling unit 120 does not executes the corresponding rapid instruction (step S340).

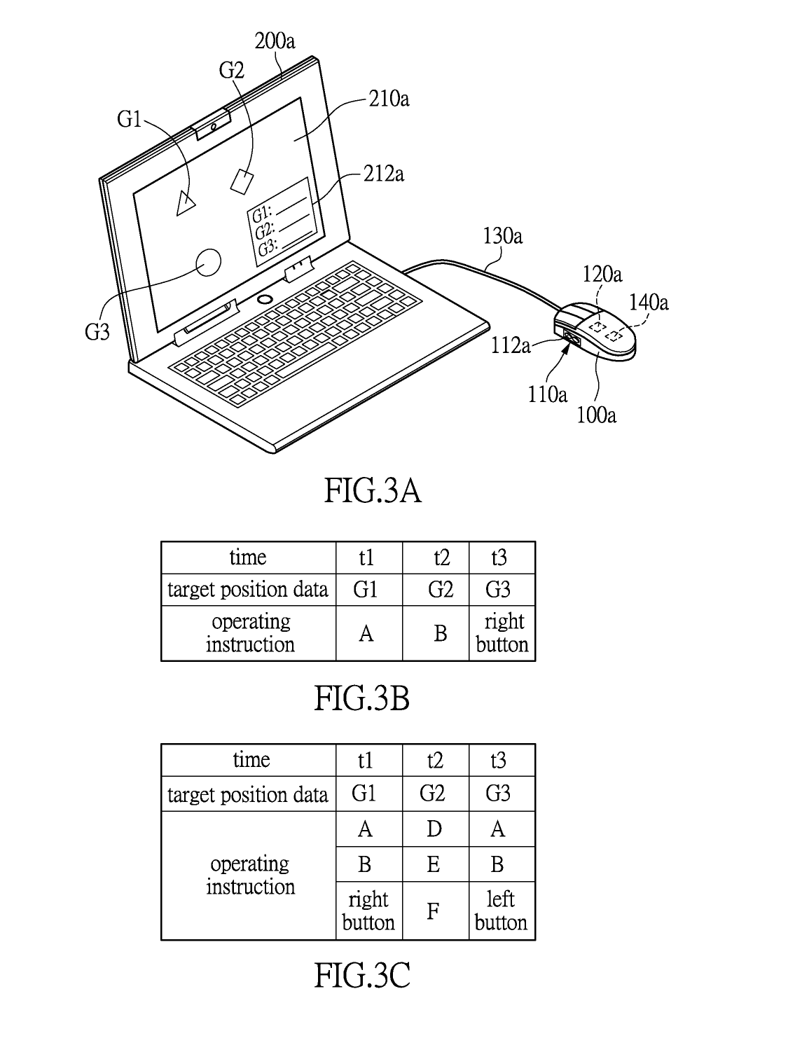

In the exemplary embodiment, the rapid instruction is obtained by a setup procedure. Each of the operating instructions corresponds to a setup time. The operating instructions are transmitted to the electronic device sequentially by the processing schedule according to the sequence of the setup time of each of the operating instructions. As shown in FIG. 3A, the setup procedure can be established on the setup field 212a of the display unit 210a. The processing schedule is formed by setting each operating instruction of the rapid instruction and the corresponding setup time for transmitting to the electronic device 200a. As shown in FIG. 3B, in the setup field 212a, the target position data G1 is configured as the operating instruction “A” at the time t1, the target position data G2 is configured as the operating instruction “B” at the time t2, and the target position data G3 is configured as the operating instruction “right mouse button” at the time t3. Then the time t1, t2, and t3 collectively form the processing schedule of the rapid instruction. The target position data G1, G2 and G3 are located on the absolute coordinate of the display unit 210a respectively and shown on the display unit 210a.

Of course, the setup field 212a may have many operating instructions at the same target position data at the same time. For example, as shown in FIG. 3C, in the setup field 212a, the target position data G1 is configured as the operating instructions “A”, “B” and “right mouse button” at the time t1, the target position data G2 is configured as the operating instruction “D”, “E” and “F” at the time t2, and the target position data G3 is configured as the operating instructions “A”, “B” and “left mouse button” at the time t3. Then the time t1, t2, and t3 collectively form the processing schedule of the rapid instruction.

In addition, the configuration of the rapid instruction may be online or offline. For example, when the user plays online game, the user can immediately set the rapid instruction in accordance with the battlefield map of the online game at that time. When the battlefield map corresponds to the whole display unit 210 and the target position data is located on a specific position of the display unit 210, the user can set the rapid instruction at offline mode, and the present invention is not limited thereto.

Subsequently, the cursor control device 100a executing the operating instruction at the target position data G1-G3 and showing on the display unit 210a are described as follows. For clarity, in the instant embodiment, the following regards the cursor control device 100a as the mouse, as shown in FIG. 3.

Firstly, the memory unit 140a of the cursor control device 100a stores a rapid instruction Because the target position data G1, G2 and G3 (i.e. the triangle, the rhombus and the circle) are located on the specific position of the display unit 210a, the rapid instruction can be set at offline mode in the setup field 212a of the display unit 210a. The setup of the rapid instruction has been described previously (as shown in FIG. 3B), and further description is hereinafter omitted.

When the user presses the function button 112a, the controlling unit 120a receives the rapid instruction corresponding to the function button 112a, the controlling unit 120a acquires the corresponding processing schedule from the memory unit 140a according to the abovementioned rapid instruction. Then the controlling unit 120a transmits the processing schedule to the electronic device 200a through the connecting unit 130a. At the same time, the operating instructions “A”, “B” and “right mouse button” of the processing schedule are transmitted to the electronic device 200a by the sequence of the time t1, t2 and t3, so that the display unit 210a displays the operating instructions “A”, “B” and “right mouse button” executed by the target position data G1, G2 and G3 respectively. In other words, that when the user presses the function button 112a, the target position data G1, G2 and G3 are shown on the specific position of the display unit 210a, and the operating instruction “A”, “B” and “right mouse button” are executed by the target position data G1, G2 and G3 respectively. When the user does not press the function button 112a, the controlling unit 120 does not execute the rapid instruction. That is to say, the target position data G1, G2, and G3 are shown on the specific position of the display unit 210a, and the operating instruction “A”, “B”, and “right mouse button” are not executed by the target position data G1, G2, and G3 respectively.

Additionally, as shown in FIG. 3C, when the rapid instruction gives many operating instructions to the same target position data in the same time frame, the controlling unit 120a transmits the operating instructions to the electronic device 200a according to the sequence of the time t1, t2, and t3 through multitasking. Then the operating instructions “A”, “B” and “right mouse button” are executed by the target position data G1 at the same time, the operating instructions “D”, “E” and “F” are executed by the target position data G2 at the same time, and the operating instructions “A”, “B” and “left mouse button” are executed by the target position data G3 at the same time.

The following description further elaborates a player employs the cursor control device 100b to play the computer game on a battlefield map and execute the operating instruction on the target position data of the battlefield map.

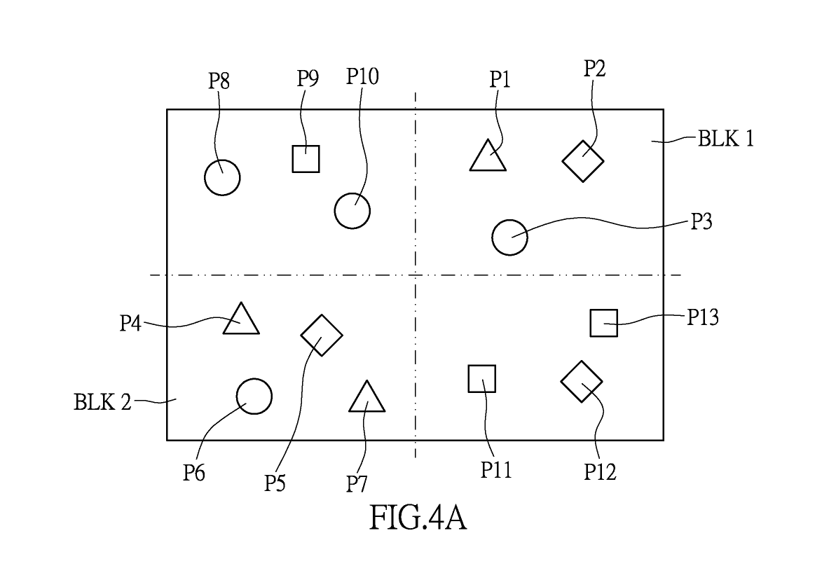

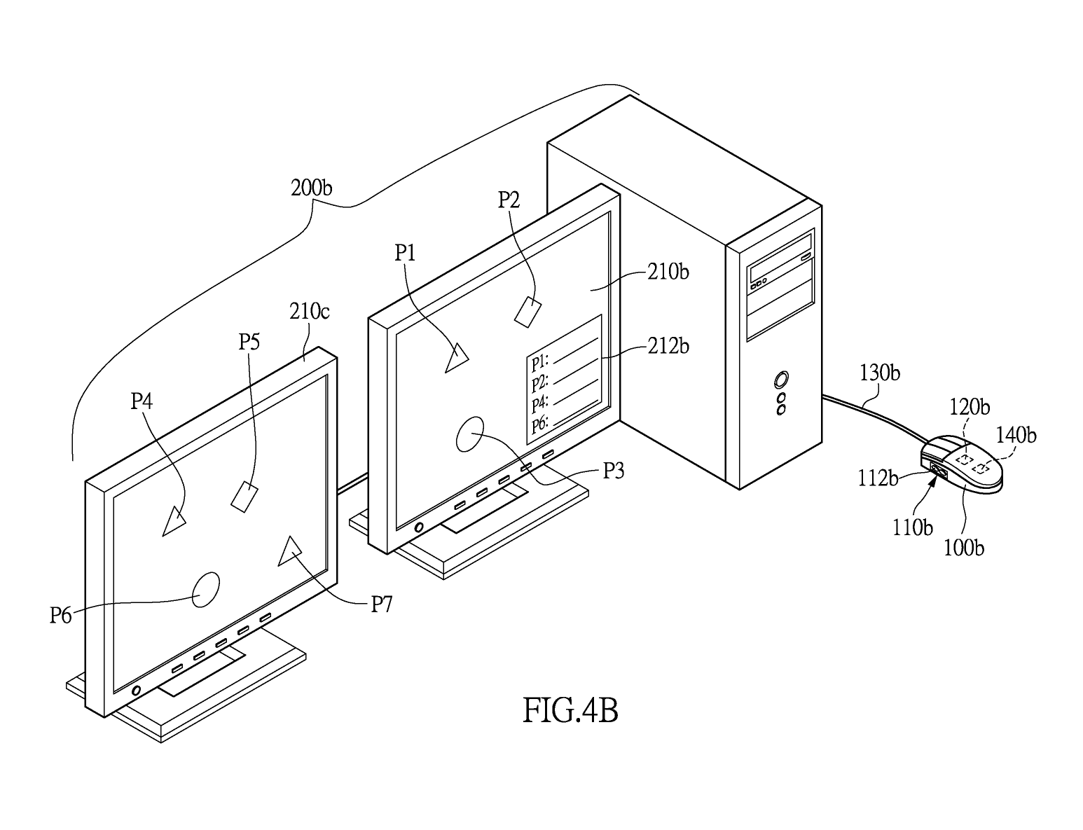

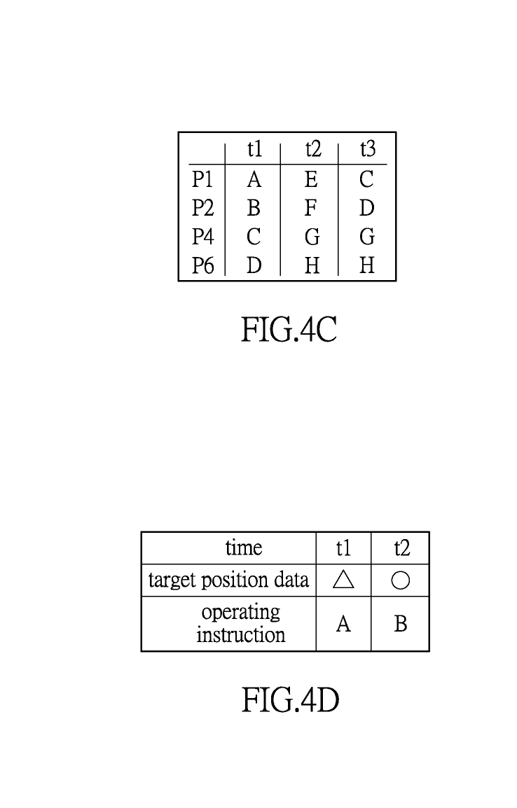

Please refer to FIG. 4A and FIG. 4B. FIG. 4A is the battlefield map. The battlefield map has the target position data P1-P13. Each of the target position data P1-P13 has a specific position located on the battlefield map, i.e. the absolute coordinate of the battlefield map. The player uses the battlefield map to play the computer game and attacks the target position data when needed. The display unit 210b is connected to the display unit 210c through a connecting line (e.g., VGA line) so as to show the different blocks of the battlefield map.

Please refer to FIG. 4B. The display unit 210b shows the target position data P1, P2 and P3 of the block BLK1, and the display unit 210c shows the target position data P4, P5, P6 and P7 of the block BLK2. In the exemplary embodiment, one half of the battlefield map and the other half of the battlefield map can be shown on the display unit 210b and the display unit 210c respectively. Accordingly, the player can view the condition of the whole battlefield map, and the present invention is not limited thereto.

Given when the player plays the computer game, the player often controls the cursor control device 100b to attack the target position data P1 and P2 of the block BLK1 and the target position data P4 and P6 of the block BLK2. The following description further elaborates the player controls the cursor control device 100b to attack the target position data P1 and P2 of the block BLK1 and the target position data P4 and P6 of the block BLK2. In addition, the target position data P1, P2 and P3 of the block BLK1 are shown on the display unit 210b, and the target position data P4, P5, P6 and P7 of the block BLK2 are shown on the display unit 210c, so that the user can monitor the real-time condition of the block BLK1 and the block BLK2. For clarity, a mouse is taken as an example of the cursor control device 100b.

Firstly, the cursor control device 100b stores a rapid instruction. The rapid instruction corresponds to the function button 112b of the operating interface 110b. In the exemplary embodiment, because the partial battlefield maps shown on the display unit 210b and the display unit 210c can be switched constantly as required. The rapid instruction spontaneously configures the target position data of the battlefield map. As shown in FIG. 4C, at the time t1, the setup filed 212b configures the target position data P1, P2, P4 and P6 executing the operating instructions “A”, “B”, “C” and “D” respectively. At the time t2, the target position data P1, P2, P4 and P6 are set as the operating instructions “E”, “F”, “G” and “H” respectively. At the time t3, the target position data P1, P2, P4 and P6 are set as the operating instruction “C”, “D”, “G” and “H” respectively. Then the time t1, t2, and t3 form the processing schedule of the rapid instruction, and the processing schedule is stored in the memory unit 140b. In the exemplary embodiment, the target position data P1, P2, P4 and P6 represent the specific positions (e.g., the absolute coordinates) of the battlefield map respectively. When the player executes the operating instructions at the target position data P1 and P2 of the block BLK1 and the target position data P4 and P6 of the block BLK2, the player presses the function button 112b. Subsequently, the controlling unit 120b receives the rapid instruction corresponding to the function button 112b.

Next, the controlling unit 120b acquires the corresponding processing schedule from the memory unit 140b according to the abovementioned rapid instruction. Then the controlling unit 120b transmits the processing schedule to the electronic device 200b through the connecting unit 130b. Meanwhile, the controlling unit 120b transmits the operating instructions to the electronic device 200b by the time t1, t2, and t3 in succession through multitasking. Then the operating instructions “A”, “B”, “C” and “D” are executed at the target position data P1, P2, P4, and P6 respectively at the time t1, the operating instructions “E”, “F”, “G” and “H” are executed at the target position data P1, P2, P4 and P6 respectively at the time t2, and the operating instructions “C”, “D”, “G” and “H” are executed at the target position data P1, P2, P4 and P6 respectively at the time t3.

Additionally, as shown in FIG. 4D, the setup field 212b can also be configured according to different features (e.g., shape or color) of the target position data. In the exemplary embodiment, the setup of the target position data is established by the shape. The target position data of the battlefield map includes circle, square, triangle and rhombus. The player establishes the target position data as triangle “Δ” and the corresponding operating instruction as “A” at the time t1. The player establishes the target position data as circle “o” and the corresponding operating instruction as “B” at the time t2. Then the time t1 and t2 form the processing schedule of the rapid instruction. The processing schedule is stored in the memory unit 140b. Thus, when the player presses the function button 112b, the target position data whose shape is circle executes the operating instruction “A” and the target position data whose shape is triangle executes the operating instruction “B” in the battlefield map. In the exemplary embodiment, the target position data P1 shown on the display unit 210b and the target position data P4 and P7 shown on the display unit 210c execute the operating instruction “A”. While the target position data P3 shown on the display unit 210b, the target position data P6 shown on the display unit 210c and the target position data P8 and P10 which are not shown on the display unit 210b or the display unit 210c execute the operating instruction “B”

In summary, the exemplary embodiments of the present invention provide the cursor control device and the input method thereof with multiple operations at one input, so as to execute one or more operating instructions on one or more target position data through the rapid instruction of the cursor control device, and then show the result on the screen. Thus, the cursor control device and the input method thereof can improve the operational convenience.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A cursor control device with multiple operations at an input, used to control a cursor, which is shown on a display unit of an electronic device, the cursor control device comprising:
a connecting unit, electrically connected to the electronic device;
an operating interface;
a memory unit, storing at least one rapid instruction, each of the rapid instruction having a plurality of target position data, and each of the target position data corresponding to at least one operating instruction; and
a controlling unit, electrically connected to the connecting unit, the operating interface and the memory unit, and the controlling unit starting and executing the rapid instruction according to the operation of the operating interface;
wherein, when the controlling unit executes the rapid instruction, the controlling unit transmits the operating instructions to the electronic device according to a processing schedule through the connecting unit so that the electronic device executes the operating instruction on each of the target position data correspondingly and displays each of the target position data on the display unit.

2. The cursor control device according to claim 1, wherein the target position data correspond to an absolute coordinate on a map or correspond to an absolute coordinate on the display unit.

3. The cursor control device according to claim 1, wherein the operating instruction is an input instruction of the operating interface and/or a keyboard command of a keyboard of the electronic device.

4. The cursor control device according to claim 3, wherein the input instruction is a command from mouse buttons and the keyboard command is a command from keyboard keys.

5. The cursor control device according to claim 1, wherein the rapid instruction is obtained by a setup procedure and each of the operating instruction corresponds to a setup time, the processing schedule outputs the operating instructions sequentially according to the sequence of the setup time of each of the operating instructions.

6. A cursor control device with multiple operations at an input, used to control a cursor, which is shown on a plurality of display units of an electronic device, the cursor control device comprising:
a connecting unit, electrically connected to the electronic device;
an operating interface;
a memory unit, storing at least one rapid instruction, each of the rapid instruction having a plurality of target position data, and each of the target position data corresponding to at least one operating instruction; and
a controlling unit, electrically connected to the connecting unit, the operating interface, and the memory unit, and the controlling unit activating and executing the rapid instruction according to the operation of the operating interface;
wherein, when the controlling unit executes the rapid instruction, the controlling unit transmits the operating instructions to the electronic device according to a processing schedule through the connecting unit so that the electronic device executes the operating instruction on each of the target position data correspondingly and displays each of the target position data on the display units.

7. The cursor control device according to claim 6, wherein the target position data correspond to an absolute coordinate on a map or correspond to an absolute coordinate on the display units.

8. The cursor control device according to claim 6, wherein the operating instruction is an input instruction of the operating interface and/or a keyboard command of a keyboard of the electronic device.

9. The cursor control device according to claim 8, wherein the input instruction is a command from mouse buttons and the keyboard command is a command from keyboard keys.

10. The cursor control device according to claim 6, wherein the rapid instruction is obtained by a setup procedure and each of the operating instruction corresponds to a setup time, the processing schedule outputs the operating instructions sequentially according to the sequence of the setup time of each of the operating instructions.

11. An input method of a cursor control device with multiple operations at an input, used to control a cursor, which is shown on a display unit of an electronic device, the input method of the cursor control device comprising:
determining whether to start a rapid instruction stored in the cursor control device, wherein the rapid instruction has a plurality of target position data, and each of the target position data corresponds to at least one operating instruction; and
executing the rapid instruction when the cursor control device starting the rapid instruction;
wherein when the cursor control device executes the rapid instruction, the cursor control device transmits the operating instructions to the electronic device according to a processing schedule so that the electronic device executes the operating instruction on each of the target position data correspondingly and displays each of the target position data on the display unit.

12. The input method of the cursor control device according to claim 11, wherein the target position data correspond to an absolute coordinate on a map or correspond to an absolute coordinate on the display unit.

13. The input method of the cursor control device according to claim 11, wherein the rapid instruction is started by operating an operating interface of the cursor control device.

14. The input method of the cursor control device according to claim 11, further comprising:
executing a setup procedure to generate the rapid instruction, wherein each of the operating instruction has a setup time.

15. The input method of the cursor control device according to claim 14, wherein the processing schedule transmits the operating instructions to the electronic device sequentially according to the sequence of the setup time of each of the operating instructions.
